(19) United States
(12) Patent Application Publication
(10) Pub. No.: US 2006/0146951 A1
(43) Pub. Date: Jul. 6, 2006

(54) System and method of processing frequency-diversity coded signals with low sampling rate

(75) Inventor: Mao-Ching Chiu, Minxiong Shiang (TW)

Correspondence Address: TROXELL LAW OFFICE PLLC;SUITE 1404, 5205 LEESBURG PIKE, FALLS CHURCH, VA, 22041, US

(73) Assignee: Integrated Programmable Communications, Inc.

(21) Appl. No.: 11/028,518

(22) Filed: Jan. 5, 2005

(51) Int. Cl. H04L 1/02

(52) U.S. Cl. 375/267

(57) ABSTRACT

A system and method of processing frequency-diversity coded signals with a low sampling rate less than the Nyquist rate for ultra-wideband devices are described. The frequency-diversity coding system comprises a frequency-diversity encoder, one or more first transformation device, a summation device, a signal filter, a sampling device, a second transformation device and a frequency-diversity decoder. The frequency-diversity encoder encodes a plurality of information blocks to output matrix elements. The first transformation devices convert the matrix elements into a plurality of OFDM symbols. The summation device superposes a plurality of frequency bands to generate a transmitted signal. The signal filter eliminates noise in the received signal. The signal filter comprises a low-pass filter for removing the noise in the received signal. The sampling device coupled to the signal filter samples the received signal by a sampling rate less than a Nyquist rate. The sampling rate is equal to the bandwidth of one subcarrier of the OFDM symbols. Additionally, the frequency-diversity decoder coupled to the second transformation device interprets the received signal to decode the information blocks.

### FIELD OF THE INVENTION

The present invention generally relates to a system and method of processing frequency-diversity coded signals, and more particularly, to a system and method of performing frequency-diversity coded orthogonal-frequency-division-multiplexing (OFDM) with a sampling rate less than the Nyquist rate for ultra-wideband (UWB) receivers.

### BACKGROUND OF THE INVENTION

Orthogonal frequency division multiplexing has been proposed for use as the physical layer of ultra-wideband systems for high-rate, short-range personal area networking (PAN). However, there is a constraint on the maximum power spectral density for the transmitted signal in the ultra-wideband systems. Therefore, the bandwidth of the transmitted spectrum must be spread widely by a bandwidth expansion scheme so that the power density of the transmitted spectrum can be kept as low as possible.

In the prior art, a problem of the frequency-diversity coding scheme is that the receiver must sample the base-band received signal using high-sampling-rate analog-to-digital converters (ADC) for discrete signal processing (DSP). However, such high-sampling-rate ADCs and DSP are expensive and have high power consumption due to their high operation frequency. In addition, the digital signal processing following the ADCs will operate in an extremely high frequency, especially for ultra-wideband systems, where the signal may be expanded over several GHz.

Ultra-wideband systems have been recently proposed for use in high-rate, short-range personal area networking, and several efforts are still under way to adopt the UWB technology as the physical layer. According to Federal Communications Commission (FCC) regulations, the transmitted power spectral density of an UWB system should be less than −41.3 dBm/Mhz. Therefore, a bandwidth expansion scheme must be employed so that the transmitted spectrum can be spread widely in order to reduce the magnitude of the power spectral density. Several modulation schemes has been proposed for UWB systems in the prior art, including impulse radio, direct sequence spread spectrum (DSSS), and orthogonal frequency division multiplexing.

OFDM combined with frequency hopping is a conventionally bandwidth expansion scheme for UWB. The frequency hopping scheme in the prior art hops to a different frequency band for each OFDM symbol during a data packet transmission, and such a mechanism is called multi-band OFDM (MB-OFDM). However, the MB-OFDM requires accurate and fast frequency synthesizing scheme for base-band signal recovery. In addition, the instantaneous power spectral density fluctuates due to the frequency hopping scheme, and hence exceeds the spectrum mask specified by FCC. This fluctuation of the instantaneous power spectral density has raised a great controversy over the question of whether MB-OFDM conforms with FCC regulations.

Consequently, there is a need to develop a novel system and method of performing frequency-diversity coded orthogonal-frequency-division-multiplexing (OFDM).

### SUMMARY OF THE INVENTION

One object of the present invention is to provide a system and method of processing frequency-diversity coded signals to solve the problem of maximum power spectral density in the ultra-wideband systems.

Another object of the present invention is to provide a system and method of processing frequency-diversity coded signals to reduce the sampling rate of the ADCs and DSP at a receiver of the frequency-diversity coding system.

According to the above objects, the present invention sets forth a system and method of processing frequency-diversity coded signals with a low sampling rate less than the Nyquist rate for ultra-wideband receivers. The frequency-diversity coding system comprise: a frequency-diversity encoder for encoding a plurality of information blocks, wherein at least one input data stream is grouped into the information blocks and each of information blocks contains a plurality of information bits so that the frequency-diversity encoder is able to output matrix elements; at least one first transformation device coupled to the frequency-diversity encoder for converting the matrix elements into a plurality of OFDM symbols; a summation device coupled to the first transformation device and a modulated device, respectively for superposing a plurality of frequency bands to generate a transmitted signal having a plurality of subcarriers; a signal filter at the receiver coupled to the summation device for eliminating noise in the received signal; a sampling device coupled to the signal filter for sampling the received signal by a sampling rate less than the Nyquist rate; and a frequency-diversity decoder coupled to a second transformation device for interpreting the received signal to decode the information blocks.

The method of performing a frequency-diversity coded signals, comprise: encoding a plurality of information blocks by using a frequency-diversity encoder wherein at least one input data stream is grouped into the information blocks and each of information blocks contains a plurality of information bits so that the frequency-diversity encoder is able to output matrix elements; converting the matrix elements into a plurality of OFDM symbols by using at least one first transformation device; superposing the frequency bands to generate a transmitted signal having a plurality of subcarriers by way of a summation device; eliminating noise in the received signal by using a signal filter at the receiver; sampling the received signal by a sampling rate less than the Nyquist rate by using a sampling device; and interpreting the received signal to decode the information blocks by using a frequency-diversity decoder. Specifically, the Nyquist rate is generally defined that the sampling rate must be at least twice the signal bandwidth.

One advantage of the proposed frequency-diversity coding scheme is that the sampling rate of the base-band ADCs and DSP at the receiver can be less then the Nyquist rate. The alias phenomenon occurs due to the reduced sampling rate, and it appears as transmission diversity to the receiver.

### BRIEF DESCRIPTION OF THE DRAWINGS

The foregoing aspects and many of the attendant advantages of this invention will become more readily appreciated as the same becomes better understood by reference to the following detailed description when taken in conjunction with the accompanying drawings, wherein:

FIG. 1 is a frequency-diversity coding system according to the present invention;

FIG. 2 is a frequency-diversity encoder as shown in FIG. 1 according to the present invention;

FIG. 3 is a flow chart of performing a frequency-diversity coding system according to the present invention; and

FIG. 4 is a comparison diagram of packet error rates of frequency-diversity uncoded and coded OFDM systems with channel model CM1.

### DETAILED DESCRIPTION OF THE PREFERRED EMBODIMENTS

In the present invention, a novel bandwidth expansion scheme is provided for UWB with OFDM modulation. The bandwidth expansion is simply achieved by a frequency-diversity coding scheme. The frequency-diversity coded OFDM expands the transmission bandwidth to Mt times larger than the original transmission bandwidth, where Mt is a positive integer greater than one. An important feature of the proposed frequency-diversity coding scheme is that it allows the receiver to sample and process the base-band received signal with a sampling rate less than the Nyquist rate. The alias phenomenon occurs due to the reduced sampling rate, and it however appears as transmission diversity to the receiver.

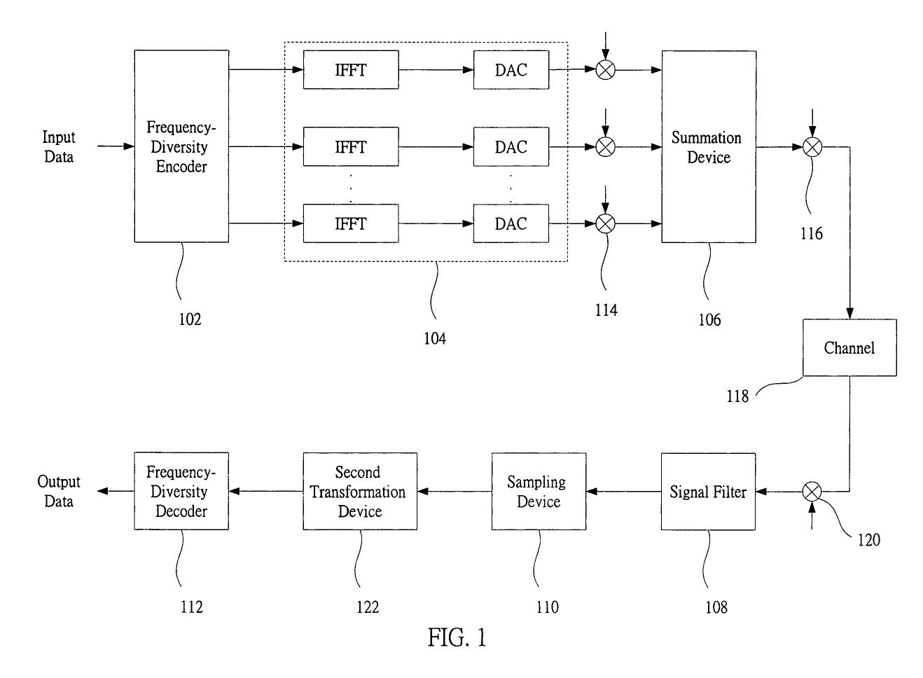

Referring to FIG. 1, a frequency-diversity coding system 100 is shown. The frequency-diversity coding system 100 comprises a frequency-diversity encoder 102, one or more first transformation device 104, a summation device 106, a signal filter 108, a sampling device 110, and a frequency-diversity decoder 112.

The frequency-diversity encoder 102 encodes a plurality of information blocks wherein at least one input data stream is grouped into the information blocks and each of information blocks contains a plurality of information bits so that the frequency-diversity encoder 102 is able to output matrix elements. The first transformation devices 104 coupled to the frequency-diversity encoder 102 convert the matrix elements into a plurality of OFDM symbols. The summation device 106 coupled to the transformation device 104 superposes a plurality of frequency bands to generate a transmitted signal having a plurality of subcarriers. The signal filter 108 is capable of eliminating noise in the received signal. The signal filter 108 at the receiver comprises a low-pass filter for removing the noise in the received signal. The sampling device 110, such as analog-to-digital converter, coupled to the signal filter 108 samples the received signal by a sampling rate less than the Nyquist rate. Specifically, the Nyquist rate is generally defined that in order to have enough information in the sample pool to reconstruct the original signal, the sampling rate must be at least twice the signal bandwidth.

The sampling rate employed in the sampling device 110 is equal to the bandwidth of one subcarrier of the OFDM symbols. Additionally, the frequency-diversity decoder 112 interprets the received signal to decode the information blocks.

In one embodiment of the present invention, the frequency-diversity coding system 100 further comprises a modulated device 114, an up-converted device 116, a channel 118, a down-converted device 120, and a second transformation device 122. The modulated device 114 coupled to the first transformation device 104 accepts OFDM symbols to modulate the OFDM symbols and expands a plurality of different frequency bands. The up-converted device 116 coupled to the summation device 106 for translating the transmitted signal of the frequency bands from lower to higher frequencies. The channel 118 coupled to the up-converted device 116 for transferring the transmitted signal. The down-converted device 120 coupled to the channel 118 translates the transmitted signal of the frequency bands from higher to lower frequencies. The second transformation device 122, such as a device performing a fast Fourier transform (FFT) algorithm, coupled to the sampling device 110 receives the transmitted signal to demodulate the transmitted signal.

The input data stream is preferably grouped into blocks, with each block containing K information bits, and each K-bit block is then encoded by a frequency-diversity encoder. The frequency-diversity encoder 102 outputs an Mₜ×N matrix where Mₜ denotes the number of frequency bands used in the bandwidth expansion scheme and may be termed as the order of transmission diversity. The Mₜ row vectors of matrix are then used to generate Mₜ OFDM symbols using the inverse fast Fourier transform (IFFT) and digital-to-analog converters (DACs) in the first transformation device 104. The Mt OFDM symbols are then modulated to different bands.

The overall transmitted signal may be viewed as an OFDM symbol with N×Mₜ subcarriers. The bandwidth of the transmitted signal is then expanded to Mₜ×f_{d}, where f_{d} is the bandwidth of one sub-band, after which, the baseband signal is up-converted by an up-converted device 116 to the carrier frequency f_{c} and transmitted over a channel 118. The up-converted device 116 coupled to the summation device 106 for translating the transmitted signal of the frequency bands from lower to higher frequencies. The channel 118 coupled to the up-converted device 116 transfers the transmitted signal. The low-pass filter at the receiver with bandwidth of (Mₜ×f_{d})/2 is preferably used to filter the out-of-band noise.

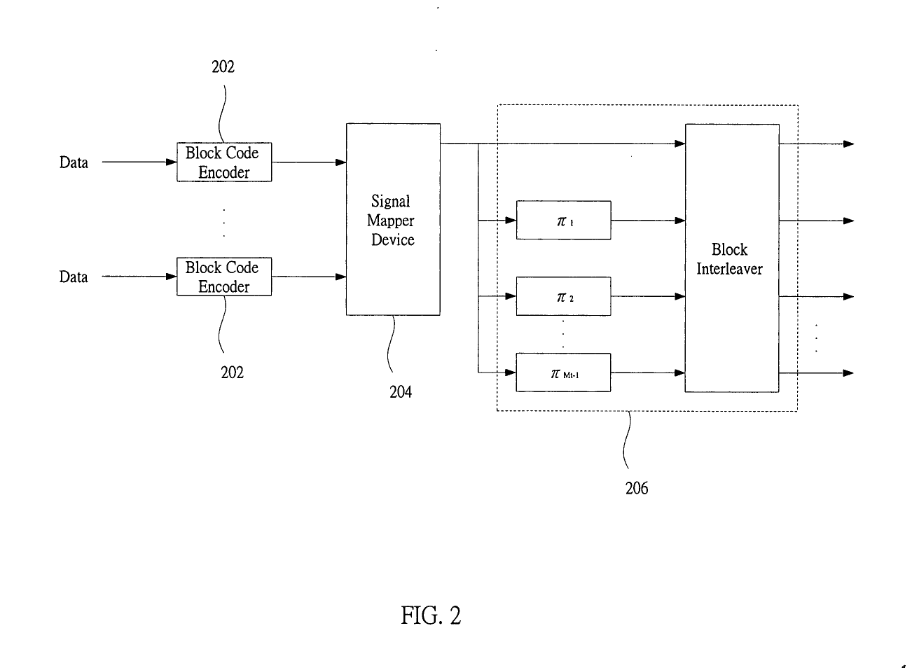

FIG. 2 illustrates a frequency-diversity encoder 200. The frequency-diversity encoder 200 comprises a plurality of block code encoders 202, a signal mapper device 204, and a block interleaver 206. The block code encoders 202 encode the information blocks into a plurality of codewords. The signal mapper device 204 coupled to the block code encoders 202 is able to map the codewords. The block interleaver 206 coupled to the signal mapper device 204 is used to permute the codewords. Specifically, by two (n, k) linear block code encoders, two k-bit information blocks are first encoded into two n-bit codewords. Two n-bit codewords are mapped into quadrature phase-shift keying (QPSK) signals of length n with each dimension modulated independently by each codeword.

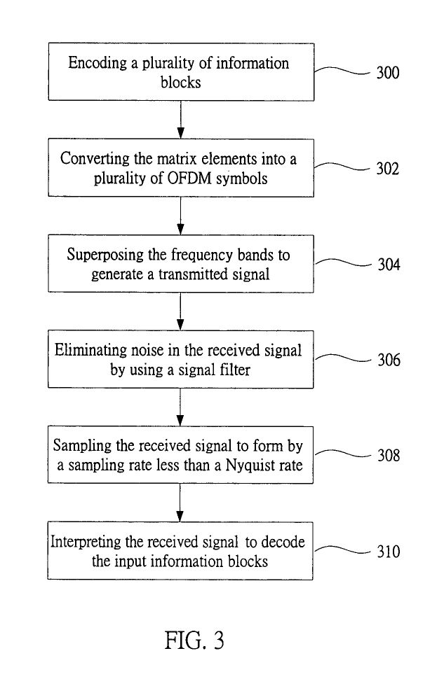

Referring to FIG. 3, a flow chart of performing a frequency-diversity coding system according to the present invention is shown. First, in step 300, a plurality of information blocks are encoded by using a frequency-diversity encoder wherein at least one input data stream is grouped into the information blocks and each of information blocks contains a plurality of information bits so that the frequency-diversity encoder is able to output matrix elements. In step 302, the matrix elements are then converted into a plurality of OFDM symbols by using at least one first transformation device. Afterwards, in step 304, a plurality of frequency bands are superposed to generate a transmitted signal having a plurality of subcarriers by way of a summation device. Further, in step 306, noise in the received signal is eliminated by using a signal filter. In step 308, the received signal is sampled significantly by a sampling rate less than the Nyquist rate by using a sampling device. Finally, in step 310, the received signal are interpreted and decoded to the information blocks by using a frequency-diversity decoder.

The design of the frequency-diversity coded OFDM allows the receiver to sample with a sampling rate less than the Nyquist rate. We consider the receiver with sampling rate fₛ=f_{d}. Therefore the received signal from the kₜₕ carrier is the summation of all the kth carriers from different diversity bands. The summation of signals from different diversity bands provides diversity gain if we properly design the frequency-diversity code.

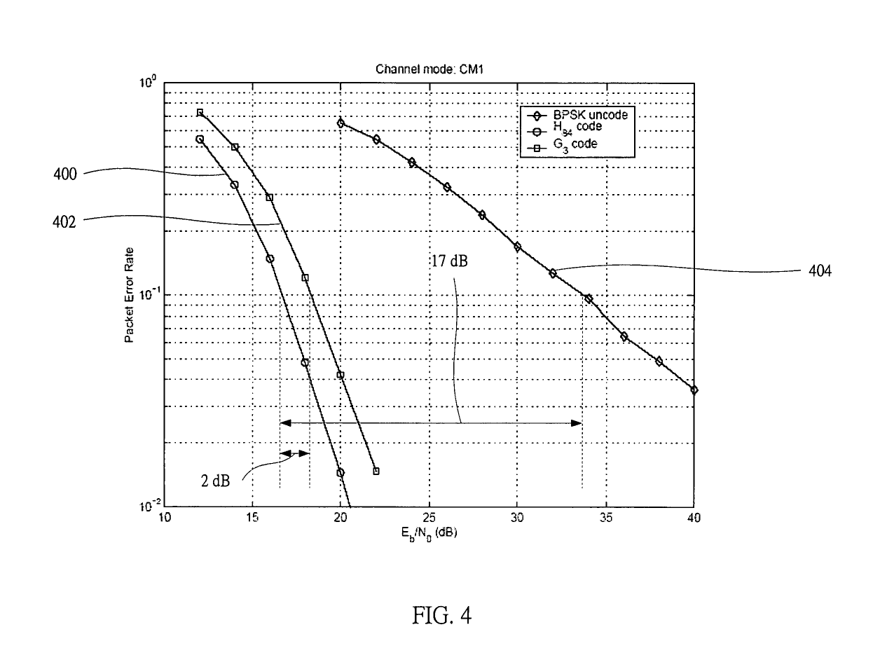

The performance of the proposed coding scheme is simulated by evaluating the packet error rate (PER) in FIG. 4. The coordinate X denotes signal-to-noise ratio (SNR) and the coordinate Y defines PER. In one embodiment of the present invention, the encoder generates a 3×128 encoding matrix. The encoding matrix is formed by means of combining sixteen matrices with size 3×8 each, and the encoding process is given as follows. Every 8-bit information block is encoded to a 3×8 matrix either by two (8, 4) Hamming code encoder denoted as H₈₄ or conventional space-time code denoted as G₃ with QPSK mapping. The sixteen 3×8 matrices are then concatenated, forming a 3×128 matrix. Then a block interleaver of degree d is employed to permute the columns of the encoding matrix, resulting the final encoding matrix.

We consider UWB channel models based on the clustering phenomenon observed in several channel measurements. The most important parameter of these models is the RMS delay spread. In the following, we also consider an uncoded OFDM system with BPSK modulation to evaluate the diversity/coding gain due to the use of frequency-diversity code. Note that the uncoded BPSK system has exactly the same data rate as that of the coded system.

Assume that the packet size is 1000 bytes and the receiver has the perfect channel state information. FIG. 4 gives the packet error rates (PER) of the H₈₄ coded OFDM (400), G₃ coded OFDM (402), and uncoded OFDM (404) for channel model CM1. For the packet error rate of 10⁻¹, the H₈₄ code (400) gives a diversity/coding gain of more than 17 dB, as compared to the uncoded BPSK (404) system. In addition, the H₈₄ code (400) outperforms the G₃ code (402) by about 2 dB. In one preferred embodiment of the present invention, longer codes should be considered for a better diversity gain. According to the above-mentioned, the codes employed in the simulation are H₈₄ (400) and G₃ (402), but not limited. Further, it is sufficient to demonstrate the effectiveness of the frequency-diversity coded OFDM system.

In conclusion, a novel frequency-diversity coded OFDM and a reduced-sampling rate receiver are provided for an ultra-wideband system in the present invention. The advantage of the proposed frequency diversity coded OFDM is that it allows the receiver to sample and process the received signal with a sampling rate less than the Nyquist rate. Thus, due to the reduced-sampling-rate receiver, the cost and power consumption of the receiver can be significantly reduced. Although the sampling rate is reduced, the receiver can also get significant diversity/coding gain by the design of the diversity codes.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A frequency-diversity coding system, comprising:
a frequency-diversity encoder for encoding a plurality of information blocks wherein at least one input data stream is grouped into the information blocks and each of information blocks contains a plurality of information bits so that the frequency-diversity encoder is able to output matrix elements;
at least one first transformation device coupled to the frequency-diversity encoder for converting the matrix elements into a plurality of OFDM symbols;
a summation device coupled to the transformation device for superposing a plurality of frequency bands to generate a transmitted signal having a plurality of subcarriers expanded from one of the OFDM symbols;
a signal filter at a receiver of the frequency-diversity coding system coupled to the summation device for eliminating noise in a received signal from the summation device;
a sampling device coupled to the signal filter for sampling the received signal by a sampling rate less than a Nyquist rate; and
a frequency-diversity decoder coupled to the sampling device for interpreting the received signal to decode the information blocks.

2. The system of claim 1, wherein the frequency-diversity encoder comprises:
a plurality of block code encoders for encoding the information blocks into a plurality of codewords;
a signal mapper device coupled to the block code encoders for mapping the codewords; and
a block interleaver coupled to the signal mapper for permuting the codewords.

3. The system of claim 1, wherein the first transformation device comprises a plurality of inverse fast Fourier transform (IFFT) device, a digital-to-analog converter device, or the combination.

4. The system of claim 1, wherein the signal filter comprises a low-pass filter for removing the noise in the received signal.

5. The system of claim 1, wherein the sampling device comprises an analog-to-digital converter.

6. The system of claim 1, wherein the sampling rate of the sampling device is equal to the bandwidth of one subcarrier of the OFDM symbols .

7. The system of claim 1, further comprising a modulated device coupled to the first transformation device for accepting OFDM symbols to modulate the OFDM symbols to expand a plurality of different frequency bands.

8. The system of claim 7, further comprising an up-converted device coupled to the summation device for translating the transmitted signal of the frequency bands from lower to higher frequencies.

9. The system of claim 1, further comprising a down-converted device for translating the transmitted signal of the frequency bands of the received signal from higher to lower frequencies via a channel.

10. The system of claim 1, further comprising a second transformation device coupled to the sampling device for receiving the signal to demodulate the received signal.

11. The system of claim 10 wherein the second transformation device further comprises a fast Fourier transform (FFT) device

12. A coding system, comprising:
a frequency-diversity encoder for encoding a plurality of information blocks wherein at least one input data stream is grouped into the information blocks and each of information blocks contains a plurality of information bits so that the frequency-diversity encoder is able to output matrix elements;
at least one first transformation device coupled to the frequency-diversity encoder for converting the matrix elements into a plurality of OFDM symbols;
a summation device coupled to the first transformation device and the modulated device, respectively for superposing multiple frequency bands to generate a transmitted signal having a plurality of subcarriers;
a sampling device at the receiver coupled to the summation device for sampling a received signal from the summation device by a sampling rate less than a Nyquist rate; and
a decoder coupled to the sampling device for interpreting the transmitted signal to decode the information blocks.

13. The system of claim 12, wherein the first transformation device comprises a plurality of inverse fast Fourier transform (IFFT) device, a digital-to-analog converter device, or the combination.

14. The system of claim 12, wherein the decoder comprises a frequency-diversity decoder.

15. The system of claim 12, wherein the sampling device comprises an analog-to-digital converter.

16. The system of claim 12, wherein the sampling rate is equal to the bandwidth of one subcarrier of the OFDM symbols.

17. The system of claim 12, further comprising a modulated device coupled to the first transformation device for accepting OFDM symbols to modulate the OFDM symbols to expand a plurality of different frequency bands.

18. The system of claim 17, further comprising an up-converted device coupled to the summation device for translating the transmitted signal of the frequency bands from lower to higher frequencies.

19. The system of claim 18, further comprising a down-converted device for translating the frequency bands of the received signal from higher to lower frequencies via a channel.

20. A method of performing a frequency-diversity coding, comprising:
encoding a plurality of information blocks by using a frequency-diversity encoder wherein at least one input data stream is grouped into the information blocks and each of information blocks contains a plurality of information bits so that the frequency-diversity encoder is able to output matrix elements;
converting the matrix elements into a plurality of OFDM symbols by using at least one first transformation device;
superposing a plurality of frequency bands to generate a transmitted signal having a plurality of subcarriers by way of a summation device;
eliminating noise in the transmitted signal using a signal filter at the receiver;
sampling the received signal by a sampling rate less than a Nyquist rate by using a sampling device; and
interpreting the received signal to decode the information blocks by using a frequency-diversity decoder.

21. The method of claim 20, during the step of encoding the information blocks comprises:
encoding the information blocks into a plurality of codewords;
mapping the codewords; and
permuting the codewords by way of a block interleaver.

22. The method of claim 20, wherein the sampling rate is equal to the bandwidth of one subcarrier of the OFDM symbols during the step of sampling the received signal.

23. The method of claim 20, further comprising accepting OFDM symbols to modulate the OFDM symbols to expand a plurality of different frequency bands by way of a modulated device coupled to the first transformation device.

24. The method of claim 23, further comprising translating the transmitted signal of the frequency bands from lower to higher frequencies.

25. The method of claim 24, further comprising translating the transmitted signal of the frequency bands from higher to lower frequencies.
